(19) United States
(12) Patent Application Publication
(10) Pub. No.: US 2012/0251086 A1
(43) Pub. Date: Oct. 4, 2012

(54) TRICK MODE TECHNIQUE FOR A BANDWIDTH LIMITED CHANNEL

(76) Inventor: Gregory William Cook, Lafayette, IN (US)

(21) Appl. No.: 13/515,576

(22) PCT Filed: Dec. 18, 2009
(86) PCT No.: PCT/US09/06646

§ 371 Date: Jun. 13, 2012

(51) Int. Cl. H04N 5/783

(52) U.S. Cl. 386/343; 386/E05.001

(57) ABSTRACT

A method for transmitting frames of fast trick mode video commences by detecting whether a frame of the fast trick video constitute an I-frame, and if so, then replacing the I frame with a dummy B-frame to maintain a target bandwidth. If the frame of video trick mode data constitutes at least one of a B or P frame, then that frame and the frame(s) predicted by the at least one B or P frame is replaced with a dummy B-frame.

### TECHNICAL FIELD

This invention relates to a technique for sending fast trick mode video across a channel having limited bandwidth.

### BACKGROUND ART

Advances in the field of communication now allow the transmission of large amounts of video data across a network from a head facility to a consumer premises to allow consumers to watch movies and other extended length audio visual content, such as television shows at the consumer's convenience. To efficiently transmit such large amounts of data, a content provider, such as a cable television operator or telephony network operator will typically compress the data using well known compression techniques, such as the MPEG 2 or MPEG 4 technique standardized by the Moving Picture Experts Group (MPEG).

The MPEG compression technique relies on the spatial and temporal similarities between frames of a video signal. Rather than send complete frames for a given video stream, the MPEG compression technique provides for conversion of a Group of Pictures (GOP) into a first or intracoded frame, referred to as an I-frame which does not depend on other frames for decoding, and intercoded frames (so called P-frames and B/b-frames) which depend on previous frames or on future and/or previous frames, respectively. A typical a group of pictures appears in FIG. 1(a). B-frames can serve as reference frames, but b-frames cannot. Typically, an I-frame contains five times more data than A P-frame, and a P-frame typically contains at least twice as much data as a B/b-frame.

Within a typical consumer premises, compressed digital video data from a cable network operator or telephony network operator undergoes storage on a storage medium, such as a hard disk drive, within a set-top box. A decoder within the set-top box converts the compressed data to uncompressed data, by a process known as decoding or decompression, before sending the uncompressed video data to a display device.

Advances in wireless technology now allow transmission of compressed digital video across a wireless link to a remote display device which includes a decoder that decompresses the data prior to data display. Very often this wireless link has a limited bandwidth. While the wireless link can handle video compressed data at a standard frame rate, fast trick mode video data (where the effective video frame rate exceeds the standard playback frame rate, either in the forward or reverse direction) can overwhelm the limited bandwidth of the wireless link unless the digital video signal undergoes recompression or modification in some way.

For example, consider a fast trick mode video having a frame rate 15× the standard playback rate. When moving through such video at such an increased frame rate with a GOP size of 15, a set-top box (not shown) can only send I-frames to the remote decoder/display as represented by the group of I-frames shown in FIG. 1(c). Such increased rate data can cause difficulties in a bandwidth limited system because the link will need to carry video at a rate in excess of three times the maximum data rate for the wireless link. Rather than send fast trick mode video at a 15× frame, the I/P frames (the first two frames of the nine-frame GOP) could undergo transmission at a 4.5× speed up as shown in FIG. 1(d).

Previous solutions for fast trick modes on bandwidth limited systems have included dropping of compressed frames when the total data rate exceeds a threshold. However, dropping frames will result in a drop in the frame rate at the remote decoder and can cause synchronization difficulties once normal playback resumes. Another approach to overcoming bandwidth limitations involves decoding and re-encoding the data so that some of the I-frames get converted into P-frames and B/b-frames. Decoding and re-encoding the data effectively lowers the data rate while maintaining the standard playback frame rate at the decoder. However, this solution requires significant computational resources.

### BRIEF SUMMARY OF THE INVENTION

Briefly, in accordance with the present principles, a method for transmitting frames of fast trick mode video commences by detecting whether a frame of the fast trick video constitute an I-frame, and if so, then replacing the I frame with a dummy B-frame to maintain a target bandwidth. If the frame of video trick mode data constitutes at least one of a B or P frame, then that frame and the frame(s) predicted by the at least one B or P frame is replaced with a dummy B-frame.

A dummy B-frame comprises a B-frame predicted from the previous frame with zero transform coefficients and a zero motion vector. The dummy B-frame uses very few bits, essentially only the bits associated with the compressed frame header. Thus replacing I and/or B or P-frames with dummy B-frames reduces the amount information in the fast trick mode video, thereby reducing the required bandwidth. Thus replacing compressed video frames with dummy B-frames creates fast trick mode video that can undergo transmission to a remote decoder/display over a limited bandwidth communications link, such as a wireless link, without exceeding bandwidth constraints for a constant video frame rate.

### BRIEF SUMMARY OF THE DRAWINGS

FIG. 1(a) depicts a first prior art Group of Pictures (GOP) that includes I, P and B/b-frames in display order;

FIG. 1(b) depicts second prior art GOP that includes I, P and B/b-frames in transmission order;

FIG. 1(c) depicts a third prior art GOP that includes all I-frames;

FIG. 1(d) depicts a fourth prior art GOP that includes I and P-frames which are a subset of a GOP;

FIG. 2 depicts a block schematic diagram of a remote display system in accordance with a preferred embodiment of the present principles for sending fast trick mode video date across a channel having limited bandwidth;

FIG. 3 depicts a block schematic diagram of a bandwidth controller comprising part of the remote display system of FIG. 2;

FIG. 4 depicts, in flow chart form the steps of a process executed by the bandwidth controller of FIG. 4 to provide a fast video trick mode stream for transmission over a limited bandwidth channel;

FIG. 5(a) depicts a Group of Pictures of a stream of fast trick mode video in which dummy B-frames replace one or more I-frames in accordance with the process of FIG. 4; and

FIG. 5(b) depicts a Group of Pictures of a fast video trick mode stream in which dummy B-frames replace one or more P and B/b-frames in accordance with the process of FIG. 4.

### DETAILED DESCRIPTION

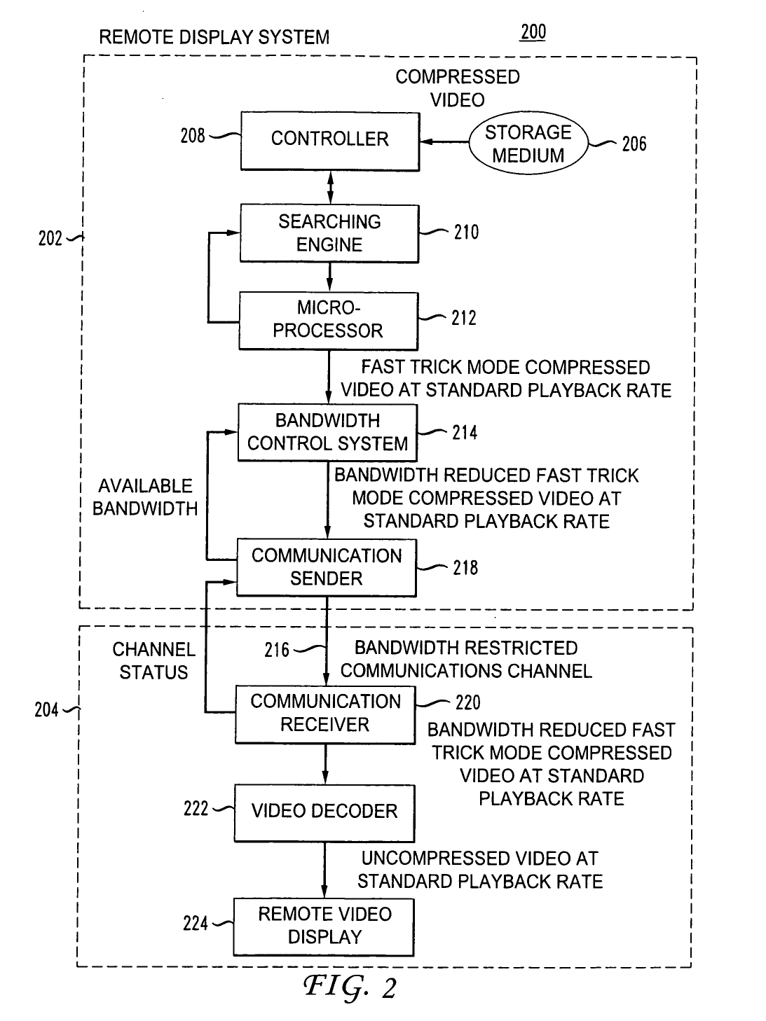

FIG. 2 depicts a block schematic diagram of a remote display system 200 in which has the capability of transmitting fast trick mode video over a limited bandwidth channel in accordance with a preferred embodiment of the present principles. The display system 200 of FIG. 2 comprises a content storage apparatus 202 for storing content in the form of movies and/or other audio-visual presentations and the like, and a remote display apparatus 204 for receiving and displaying content from the content storage apparatus 202.

The content storage apparatus 202 typically takes the form of a set-top box, gateway, satellite receiver, or the like which interfaces with a content source (not shown) which can take the form of, a head end in the case of a set-top box or gateway or a satellite in the case of a satellite receiver. Alternatively, the content storage apparatus 202 can take the form of a personal computer, personal video recorder or DVD player for example. As will become better understood hereinafter, the exact nature of the content storage apparatus does not play a critical role, as long as the content storage apparatus possesses the capability of controlling the bandwidth of the fast trick mode video communicated to the remote display 204 in accordance with the present principles.

Referring to FIG. 2, the content storage apparatus 202 includes a storage medium 206 for storing content, in the form of compressed video and/or audio received from an external content source (not shown). For ease of illustration, the circuitry associated with interfacing with the content source for processing such content for storage on the storage medium 206 does not appear. Such circuitry is well known in the art and its structure will typically depend on the nature of the content storage apparatus 202 and its associated external content source.

The particular structure of the storage medium will depend on the nature of the content storage apparatus 202. In the case where the content storage apparatus 202 comprises a set-top box, gateway, satellite receiver, personal computer or personal video recorder, the storage medium 206 would likely take the form of a hard disk drive, or even a combination of such drives arranged in a RAID array. In the case where the content storage apparatus 202 comprises a DVD player, the storage medium 206 typically comprises an optical drive for reading content from a DVD or a CD. A controller 208 controls the storage medium 206 for retrieving stored content therefrom. A search engine 210 operating under the control of a microprocessor 212, serves to remove frames from a stored content to yield fast trick mode video corresponding the content undergoing playback, but capable of reproduction at a trick mode speed. In practice, the search engine 210 can comprise a software program executed by the microprocessor 212 or a combination of both hardware and software.

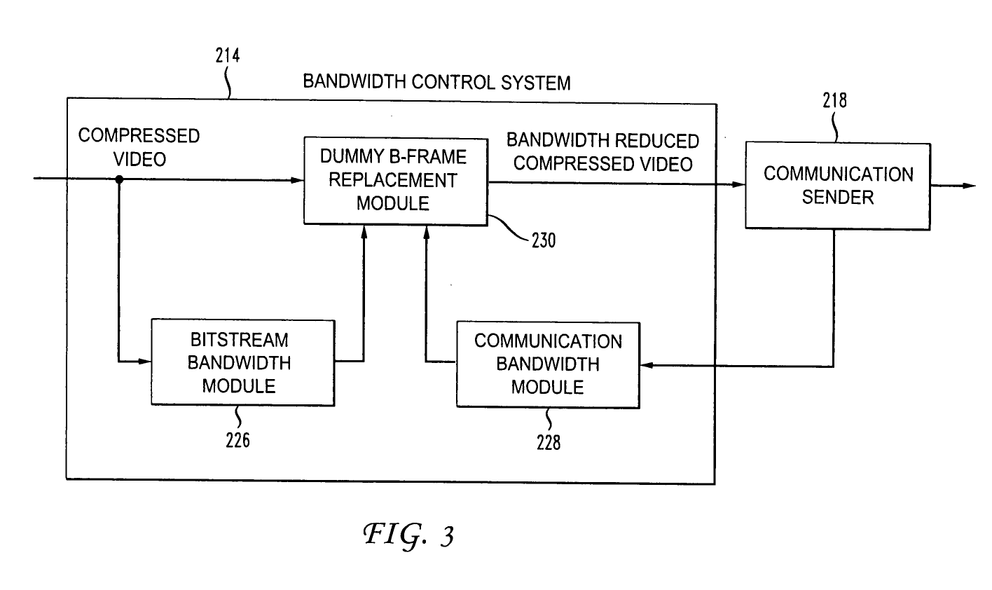

In accordance with the present principles, a bandwidth control system 214, described in greater detail with respect to FIG. 3, controls the bandwidth of content, including fast trick mode video, communicated to the remote display unit 204 across a limited bandwidth channel 216 via a communications sender 218. In practice, the limited bandwidth channel 216 comprises a radio channel, whereas the communications sender 218 comprises a radio transmitter.

In practice, the communications sender 218 possesses the ability to communicate video and/or audio information across the radio channel 216 for normal speed playback without bandwidth constraints. However, the transmission of fast trick mode video often imposes bandwidth constraints given the need to transmit larger amounts of information during an interval of a given length to achieve playback of video at trick play speeds. To overcome bandwidth constraints, the bandwidth control system 214 advantageously replaces frames in the fast trick mode video with dummy B-frames in accordance with the present principles. Replacing frames in the fast trick mode video with dummy B-frames serves to modify the fast trick mode video to reduce the required bandwidth while assuring a constant frame rate. A dummy B-frame comprises a B-frame predicted from the previous frame with zero transform coefficients and a zero motion vector. The dummy B-frame uses very few bits, essentially only the bits associated with the compressed frame header.

The remote display system 204 of FIG. 2 typically takes the form of a tablet or other type of hand-held device. Within the remote display system 204, a communications receiver 220 receives content, including but not limited to fast trick mode video, transmitted across the channel 216 by the communications sender 218. A video decoder 222 within the remote display system 204 decodes the content received by the communications receiver 220 for display on a remote display device 224 which can include an LCD display or the like.

Referring to FIG. 3, the bandwidth control system 214 typically comprises a bit stream bandwidth module 226 that receives incoming content for determining current bandwidth associated with such content. A communications bandwidth module 228 within the bandwidth control system 214 receives information from the communications sender 218 of the content storage apparatus of FIG. 2 indicative of a target channel bandwidth. Based on the current bandwidth determined by the bandwidth bit stream module 226 and the target bandwidth established by the communications bandwidth module 228, a third module, referred to as the dummy B-frame replacement module 230, makes decisions on which frames of the content drop and replace with dummy B-frames. In accordance with the present principles, when the current bandwidth of the content for transmission to the remote display system 204 of FIG. 2 exceeds the target channel bandwidth (as typically occurs with fast trick mode video), the dummy B-frame replacement module 230 of FIG. 3 replaces one of more frames with dummy B-frames to reduce the bandwidth while maintaining a constant frame rate. In practice, the modules 226, 228 and 230 of the bandwidth control system can collectively comprise a microprocessor executing one or more programs to perform the functions described previously. Alternatively, each module can comprise a combination of software and hardware for executing the described functions.

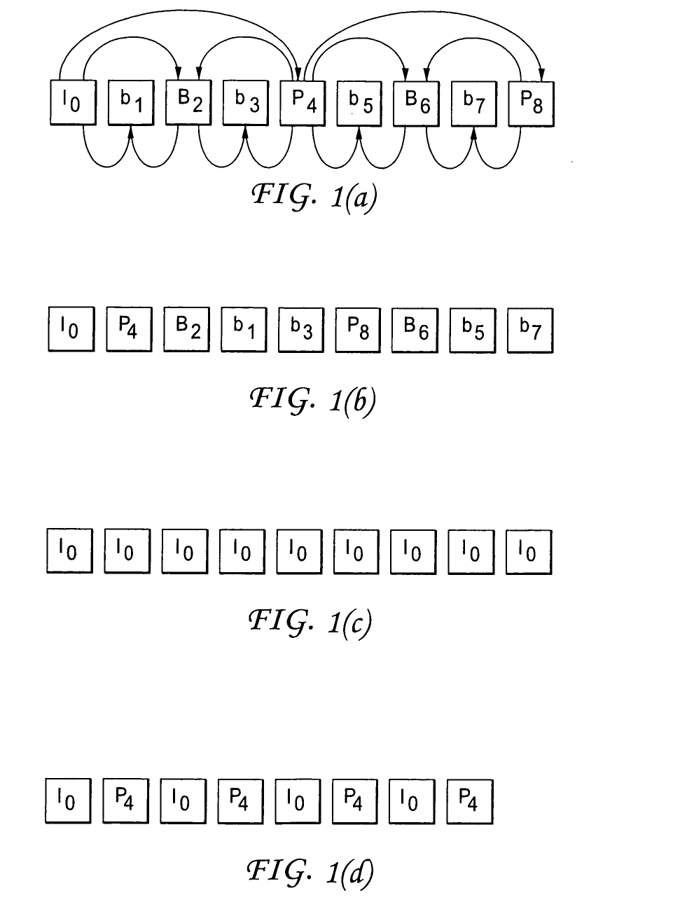

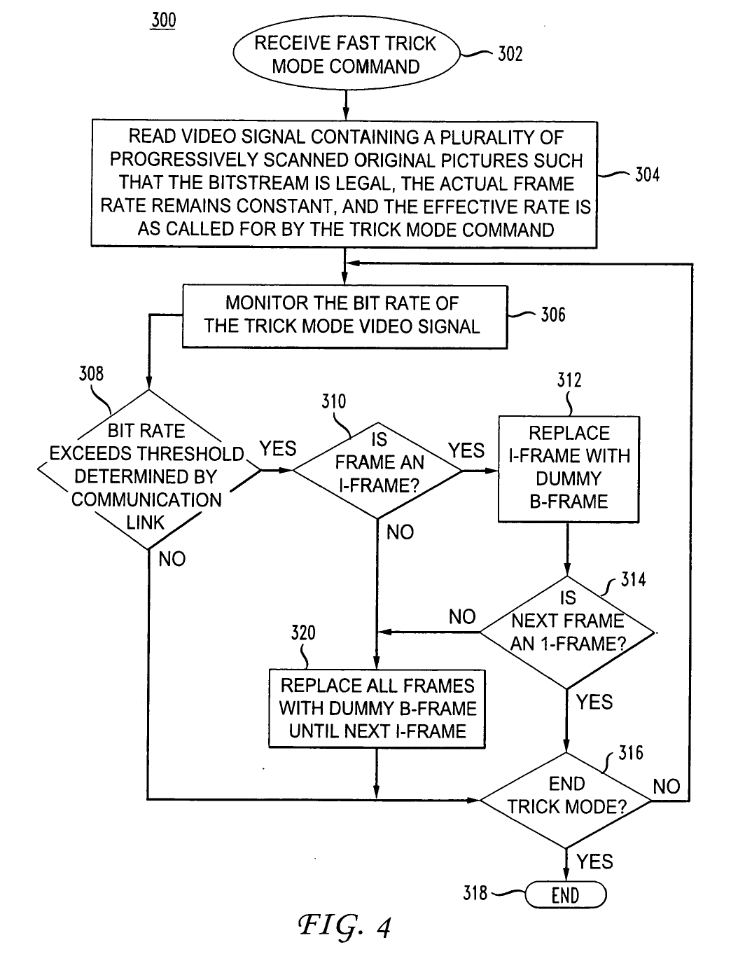

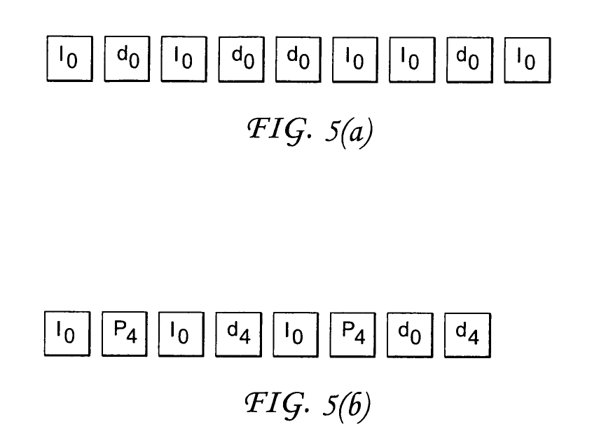

As described in greater detail hereinafter with respect to the flowchart of FIG. 4, the dummy B-frame replacement module 230 takes into account two possibilities with respect to replacement of dropped frames with dummy B-frames. In particular, the frame dropping and frame replacement performed by the dummy B-frame replacement module 230 differs depending on whether only I-frames appear in the fast trick mode video or whether P-frames and B/b-frames also appear (in additions to the I-frames). To better understand why frame replacement differs, refer to FIG. 1(c) which depicts a sequence of frames corresponding to a stream of fast trick mode video at 9× the standard frame rate, with only the first I-frame of each GOP undergoing transmission. When the stream comprises only I-frames, then the dummy B-frame replacement module 230 will drop or more I-frames and replace the dropped frames with dummy B-frames as shown in frame sequence depicted in FIG. 5(a) with each remaining I-frame represented by I₀ and each dummy B-frame represented by d₀.

The fast trick mode video can include I-frames and P and B/b-frames as well as depicted by the frame sequence in FIG. 1(b). For any reference frame (I, P, and/or B) dropped using the method of the present principles, then all frames which reference (or are predicted from) the dropped frame must also be dropped. Otherwise a non-compliant bit stream will result. Note that sending P-frames and B-frames likely would not cause the bit rate to exceed a threshold. To account for the presence of both I P and B/b-frames, when the dummy B-frame replacement module 230 detects an increase in the bandwidth above a threshold, the module will drop of the I-frame and all P-frames and B-frames that follow, and replace such dropped frames by dummy B-frames.

To the extent more sophisticated shaping becomes necessary using the P-frames, then if a P-frame exceeds the bandwidth threshold, all following P-frames and B-frames get dropped and replaced with dummy B-frames until the next I-frame. FIG. 5(b) depicts a stream of in which P-frames and I/P-frames have been dropped. Note that in the last frame in the sequence in FIG. 1(a), P8, is predicted from the previous reference frame, which is P4. In FIG. 1(b), it is shown that P-frames and B-frames do not get transmitted in display order. Thus, the dummy B-frame replacement module 230 could determine the bandwidth to exceed the threshold when actual rate would not exceed the threshold. This event would constitute a rare occurrence, however, and would not greatly impact the technique of the present principles. However, to avoid such a problem, the microprocessor 212 of FIG. 2 could read ahead and determine the bit rate over the modified GOP.

FIG. 4 depicts in flow chart form the steps of a process 300 executed by the bandwidth control system 214 of FIGS. 2 and 3 to drop frames and replace such dropped frames with dummy-B frames in accordance with the present principles. The process 300 of FIG. 4 commences upon receipt at the bandwidth control system 214 of retrieved content in the form of a video signal which could contain fast trick mode video (step 302). Next, the video signal read during step 302 undergoes analysis during step 304 to determine that the video signal meets the criterion of a “legal” bit stream, that is, that the bit stream has a constant frame rate and that the effective frame rate corresponds to the rate specified for fast trick mode video if the stream constitutes such video.

For retrieved content constituting fast trick mode video, the bandwidth control system 214 of FIGS. 2 and 3 will execute step 306 of FIG. 4 and monitor the bit rate of the fast trick mode video. During step 308, a check is made whether the fast trick mode video has a bit rate that exceeds the bit rate of the communications link 216 of FIG. 2. If so, then a check occurs during step 310 whether the frame of the fast trick mode video comprises an I-frame. If so, then the bandwidth control system 214 of FIGS. 2 and 3 replaces the I-frame with a dummy B-frame during step 312. Thereafter, a check occurs during step 314 whether the next frame constitutes an I-frame. If so, then a check occurs during step 316 whether the fast trick mode video has ended. Step 316 will also undergo execution should the bandwidth control system 214 of FIGS. 2 and 3 determine that the bit rate does not exceed the threshold rate of the communications following execution of step 308. Upon determining the fast trick mode video has ended during step 316, then the process ends at step 318. In the event that fast trick mode video has not ended following the check made during step 316, the process branches back to step 306.

Should the check performed during step 310 determine that the frame under consideration does not constitute an I-frame, then step 320 undergoes execution at which time the bandwidth control system 214 of FIGS. 2 and 3 replaces all frames with dummy B-frames until the next I-frame. Step 320 also undergoes execution following step 314 when the next frame constitutes something other than an I-frame. Following step 320, step 316 undergoes execution to determine whether the fast trick mode video has ended.

The foregoing describes a technique for sending fast trick mode video across a channel having limited bandwidth.

1. A method for transmitting frames of fast trick mode video, comprising the steps of:
(a) detecting whether a frame of the fast trick video constitute an I-frame, and if so, then replacing the I frame with a dummy B-frame to maintain a target bandwidth, but
(b) if the frame of video trick mode data constitutes at least one of a B or P frame, then replacing the at least one B or P frame and frame(s) predicted by the at least one B or P frame with a dummy B-frame.

2. The method according to claim 1 wherein steps (a) and (b) are repeated for each successive frame of fast trick mode video.

3. A method for transmitting frames of fast trick mode video, comprising the steps of:
(a) determining whether transmission of a frame of the fast video trick mode transmission exceeds a threshold bit rate of a transmission link; and if so, then
(b) detecting whether the frame of the fast trick video constitute an I-frame, and if so, then replacing the I frame with a dummy B-frame to maintain a target bandwidth, but
(c) if the frame of video trick mode data constitutes at least one of a B or P frame, then replacing the at least one B or P frame and frame(s) predicted by the at least one B or P frame with a dummy B-frame.

4. The method according to claim 3 wherein steps (a)-(c) are repeated for each successive frame of fast trick mode video.

5. A remote display system, comprising:
a source of content;
a remote display for displaying fast trick mode data provided by the source of content;
a communications channel for transmitting fast trick mode video from the content source to the remote display; and
bandwidth communications manager means for:
(a) determining whether transmission of a frame of the fast video trick mode transmission exceeds a threshold bit rate of a transmission link; and if so, then
(b) detecting whether the frame of the fast trick video constitute an I-frame, and if so, then replacing the I frame with a dummy B-frame to maintain a target bandwidth, but
(c) if the frame of video trick mode data constitutes at least one of a B or P frame, then replacing the at least one B or P frame and frame(s) predicted by the at least one B or P frame with a dummy B-frame.

6. The remote display system according to claim 5 wherein the source of content and the bandwidth communication manager means collectively comprise one of a set-top box, gateway, satellite receiver, personal computer, personal video recorder or DVD player.

7. A content storage apparatus for transmitting content, including fast trick mode video:
a source of content for proving ;
a communications sender for transmitting fast trick mode video from the content source to the remote display; and
bandwidth communications manager means for:
(a) determining whether transmission of a frame of the fast video trick mode transmission exceeds a threshold bit rate of a transmission link; and if so, then
(b) detecting whether the frame of the fast trick video constitute an I-frame, and if so, then replacing the I frame with a dummy B-frame to maintain a target bandwidth, but
(c) if the frame of video trick mode data constitutes at least one of a B or P frame, then replacing the at least one B or P frame and frame(s) predicted by the at least one B or P frame with a dummy B-frame.
